(19) United States
(12) Patent Application Publication
(10) Pub. No.: US 2026/0170534 A1
(43) Pub. Date: Jun. 18, 2026

(54) METHOD OF SUPPORTING ASSESSMENT OF USER INTERACTION WITH CONTENT

(71) Applicant: Doximity, Inc., San Francisco, CA (US)

(72) Inventors: Jeffrey Alan Tangney, Palo Alto, CA (US); Jey Balachandran, New York, NY (US); Joseph B. Kleine, Nashville, TN (US); John Stuart Noble, Chicago, IL (US); Andrew Jayhoon Chung, San Francisco, CA (US); James Michael Badwick, Reno, NV (US); Callum Patrick Dolan Colvine, Calgary (CA); Peiken Hu, Portland, OR (US); Fellipe Sebastiam da Silva Paranhos Pereira, Rio de Janeiro (BR); Ria Khanna, Dublin, CA (US); Anastasia Chukwudimma Okoye, Elkridge, MD (US); Rocco Stanzione, III, Allen, TX (US); Lucas Cercal Lazzaris, Florianopolis (BR)

(21) Appl. No.: 18/983,176

(22) Filed: Dec. 16, 2024

(51) Int. Cl. G06Q 30/0241

(52) U.S. Cl. CPC G06Q 30/0247; G06Q 30/0249; G06Q 30/0277

(57) ABSTRACT

A method comprises determining, by a processing device, a target value for a behavior metric based on campaign data for a content campaign. The method includes monitoring behavior data corresponding to the behavior metric during the content campaign. The method includes generating a notification indicating whether the behavior data meets the target value.

### FIELD OF DISCLOSURE

This disclosure relates generally to user interactions with content, and more particularly to supporting assessment of user interaction with content.

### BACKGROUND

Users of computing devices are regularly presented and interact with content, such as videos and articles. The content presented to users may be associated with enterprises seeking to achieve particular objectives through presentation of the content, such as promoting user awareness or causing users to choose a product. For example, informational content for pharmaceutical products can be presented to physicians to educate the physicians on the benefits of prescribing such medications. Accordingly, these enterprises can create informational campaigns to distribute the content to the users.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the scope of the described embodiments.

To easily identify the discussion of any particular element or act, the most significant digit or digits in a reference number refer to the figure number in which that element is first introduced.

FIG. 1 illustrates an example network architecture, in accordance with one or more embodiments of the disclosure.

FIG. 2 illustrates an exemplary operating environment for supporting assessment of user interactions with content, in accordance with one or more embodiments of the disclosure.

FIG. 3 illustrates a graphical user interface (GUI) provided by a networking platform, in accordance with one or more embodiments of the disclosure.

FIG. 4 illustrates a GUI provided by a networking platform, in accordance with one or more embodiments of the disclosure.

FIG. 5 illustrates a flowchart of a method of supporting assessment of user interactions with content, in accordance with one or more embodiments of the disclosure.

FIG. 6 illustrates a GUI provided by a networking platform, in accordance with one or more embodiments of the disclosure.

FIG. 7 illustrates a GUI provided by a networking platform, in accordance with one or more embodiments of the disclosure.

FIG. 8 illustrates a GUI provided by a networking platform, in accordance with one or more embodiments of the disclosure.

FIG. 9 illustrates a block diagram of an example system, in accordance with one or more embodiments of the disclosure.

### DETAILED DESCRIPTION

The following description sets forth numerous specific details such as examples of specific systems, components, methods, and so forth, in order to provide a good understanding of various embodiments of the techniques described herein for supporting assessment of user interaction with content. It will be apparent to one skilled in the art, however, that at least some embodiments may be practiced without these specific details. In other instances, well-known components, elements, or methods are not described in detail or are presented in a simple block diagram format in order to avoid unnecessarily obscuring the techniques described herein. Thus, the specific details set forth hereinafter are merely exemplary. Particular implementations may vary from these exemplary details and still be contemplated to be within the scope of the present disclosure.

As discussed above, an enterprise can create informational campaigns to distribute content to users. For example, the enterprise, or an agent of the enterprise, may use a networking platform to facilitate the dissemination of information to various consumers. The enterprise may be a manufacturer of a pharmaceutical product, and the enterprise can engage an agent operating the networking platform to provide information about the pharmaceutical product to physicians. This information, or content, may be presented to and consumed by the physicians, which can affect a likelihood that the physicians may act on the information, e.g., by prescribing the pharmaceutical product.

Existing networking platforms, however, may not provide functionality that extensively supports accurate and reliable assessments of content performance by enterprises. For example, existing systems cannot predict, when creating the content campaigns, a degree to which the consumers will interact with the content. Furthermore, enterprises are unable to assess whether consumers have interacted with the content to the degree predicted. Such shortcomings create uncertainty, and perhaps reluctance, for enterprises when determining whether to invest in such beneficial informational campaigns. More particularly, these limitations can reduce accessibility, usability, reliability, and capabilities of networking platforms, contributing to systems with non-optimal functionality and client experiences.

In an aspect, an enterprise initiating an informational campaign can use a self-serve portal of a system for supporting assessment of user interactions with content. The enterprise can input campaign data into the system, e.g., data representing information about the campaign, such as a campaign budget, informational tactics, campaign duration, etc. The system may determine, based on such data, a guarantee of physician engagement. Physician engagement can encompass whether content will be accessed or accessed to a certain degree. Guarantees may also be made for an amount of prescriptions that the physician will make. Accordingly, the enterprise can initiate the informational campaign with confidence that an objective to educate or influence physicians will be achieved through the campaign, or that the informational campaign will affect the likelihood that physicians may act on the information.

In an aspect, the self-serve portal of the system allows for real-time assessment of how well an informational campaign is tracking against the guarantee of physician engagement. For example, the system can monitor physician engagement and generate notifications or alerts indicating whether content is being accessed or accessed to the level that was predicted. Accordingly, the enterprise can receive ongoing feedback confirming whether the informational campaign is achieving the objective to educate physicians.

Embodiments disclosed herein provide techniques, functions, and features for supporting assessment of user interactions with content, such as articles and videos. For example, a behavior metric can be used to assess engagement of users with content. A target value for the behavior metric can be determined, e.g., predicted, based on campaign data provided by an enterprise. More particularly, based on such campaign data, an operation of a networking platform can determine a degree to which the enterprise can expect to inform or influence users. The prediction can be provided in the form of a guarantee of engagement level or prescriptions generated per amount invested in the content campaign. Furthermore, the actual engagement or prescriptions of the users may be monitored and the enterprise can be notified or alerted to whether the content campaign is producing the expected result. Accordingly, the methods and systems described herein can increase usability, reliability, and capabilities of networking platforms, contributing to systems with enhanced functionality and client experiences.

Components/techniques described herein may provide many technical advantages for supporting assessment of user interactions with content. Furthermore, the techniques and features described hereby provide particular ways of programming or designing software to determine and present metrics on user interactions with client content. The techniques and functionalities provide a specific interface and implementation for evaluating complex interactions with a multitude of content items of various formats in an intuitive and efficient manner using techniques unique to computers, such as a dynamically updated graphical user interfaces that present performance metrics calculated based on analysis of monitoring data received via a computer network. Therefore, the computer-based techniques of the current disclosure improve the functioning of networking platforms, resulting in better capabilities and improved user experiences as compared to conventional approaches. Accordingly, embodiments disclosed hereby can be practically utilized to improve the functioning of a computer and/or to improve a variety of technical fields including networking platforms, content analysis, user interfaces, user experience, and human-machine interfaces.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

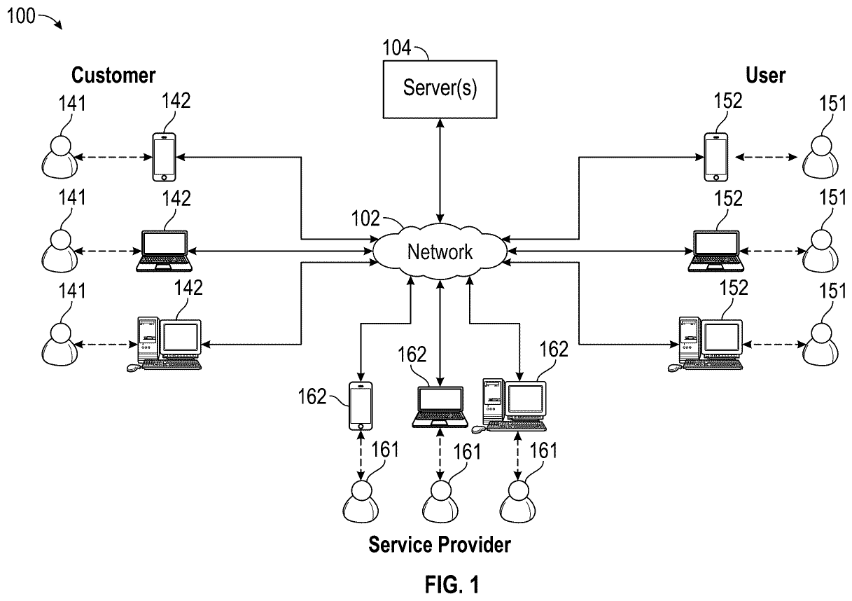

Referring to FIG. 1, an example network architecture is shown in accordance with one or more embodiments of the disclosure. A network architecture 100 includes a network 102, servers 104, customers 141, computing devices 142, users 151, computing devices 152, service providers 161, and computing devices 162.

In one embodiment, the customers 141 may be representatives of enterprises interested in initiating informational campaigns to educate users 151. Each customer 141 may use a computing device 142 to communicate with the server(s) 104. Examples of computing devices 142 may include, but are not limited to, a smartphone, a tablet computer, a laptop computer, a desktop computer, etc.

In one embodiment, the users 151 may be people who provide health related services and/or products to others. Examples of users 151 may include, but are not limited to, doctors, pharmacists, dentists, nurses, therapists, psychologists, technicians, surgeons, etc. Each user 151 may use a computing device 152 (e.g., smartphone, tablet computer, etc.) to access informational content related to the health related products. More particularly, the users 151 can access the informational content through a networking platform provided by the server(s) 104.

In one embodiment, a service provider 161 may create or publish informational content that is provided by the server(s) 104. For example, the service provider can be an advertising agency that creates articles or videos related to the health related products. Each service provider 161 may use a computing device 162 (e.g., smartphone, tablet computer, etc.) to communicate with the server(s) 104.

The server(s) 104 may be maintained by an entity that provides the networking platform. The networking platform can allow physicians to interact with each other and become educated on beneficial tools and products to treat patients. For example, the networking platform may publish content that the physicians can interact with, e.g., read an article or watch a video, to provide more informed health services. The entity can contract with the customers 142 to deliver the content campaigns to the users 152, e.g., using content generated by the service providers 162.

A communications architecture suitable for implementing various embodiments as previously described, such as communications between computing devices can include various common communications elements, such as a transmitter, receiver, transceiver, radio, network interface, baseband processor, antenna, amplifiers, filters, power supplies, and so forth. The embodiments, however, are not limited to implementation by the communications architecture.

The network architecture 100 provides a communications architecture having one or more client(s) and server(s). In some embodiments, each client and/or server may include a computing system (e.g., a computing device). The server(s) may implement one or more devices or components of the networking platform. The client(s) and the server(s) are operatively connected to one or more respective client data store(s) and server data store(s) that can be employed to store information local to the respective client(s) and server(s), such as cookies and/or associated contextual information. In various embodiments, any one of the server(s) may implement one or more logic flows or operations described hereby, such as in conjunction with storage of data received from any one of the client(s) on any of the server data store(s). In one or more embodiments, one or more of client data store(s) or server data store(s) may include memory accessible to one or more portions of components, applications, and/or techniques described herein.

The client(s) and the server(s) may communicate information between each other using a communication framework of the network 102. The communication framework may implement any well-known communications techniques and protocols. The communication framework may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework of the network 102 may implement various network interfaces arranged to accept, communicate, and connect to the communications network. A network interface may be regarded as a specialized form of an input/output (I/O) interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.7a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount of speed and capacity, distributed network controller architectures may similarly be employed to pool, load balance, and otherwise increase the communicative bandwidth required by client(s) and the server(s). The communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other

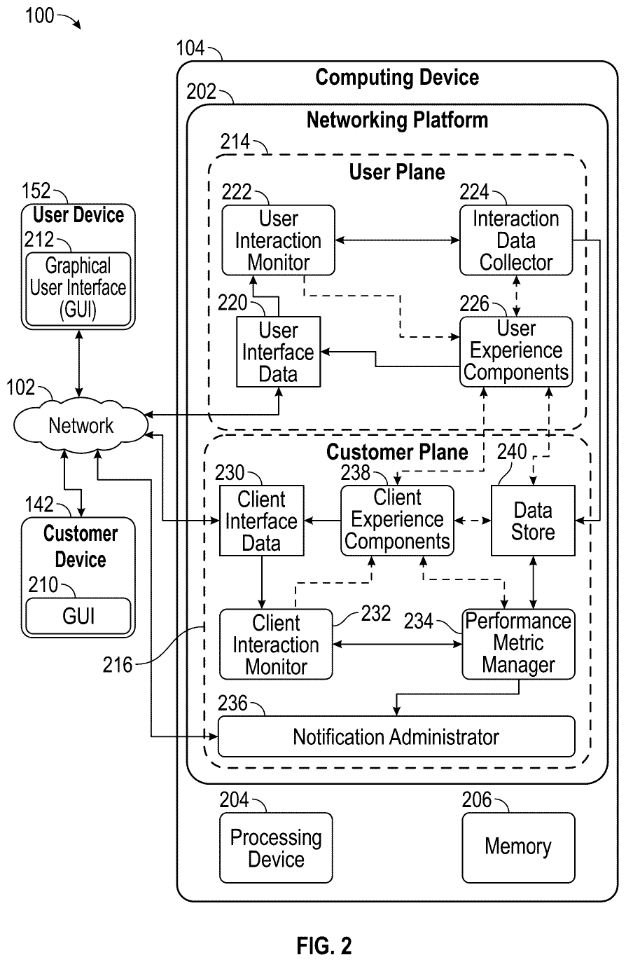

Referring to FIG. 2, an exemplary operating environment for supporting assessment of user interactions with content is shown in accordance with one or more embodiments of the disclosure. The operating environment includes a computing device of the server(s) 104. The server(s) 104 communicate with a computing device 142 of a customer 141, and with a computing device 152 of a user 151 via the network 102. The server 104 includes a networking platform 202, a processing device 204, and a memory 206. The memory 206 and the processing device 204 are operatively coupled such that data, e.g., campaign data, stored in the memory can be used by the processing device to perform the method described below. More particularly, the server 104 provides a system to perform the method described below.

The customer device 142 includes a first graphical user interface (GUI) 210 and the user device 152 includes a second GUI 212. The GUI 210 of the user device 152 may be utilized to interact with a user plane 214 of the networking platform 202 via network 102 and the GUI 142 of the customer device 142 may be utilized to interact with a client plane 216 of the networking platform 202 via network 102. Generally, the user plane 214 may be utilized by consumers of content on the networking platform 202 (referred to as users) and the customer plane 216 may be utilized by entities running informational campaigns on the networking platform 202 (referred to as customers or clients). In many embodiments, the techniques disclosed hereby relate to providing new and useful techniques to enable a client to more accurately and reliably predict and assess interactions of users with informational content provided by the informational campaign, such as by tracking, determining, and presenting metrics corresponding to user interactions with content on the networking platform 202.

The networking platform 202 may operate to facilitate the dissemination of information to users of the networking platform. For example, the networking platform 202 may provide a source of healthcare information to healthcare professionals. This information, or content, may be presented to and consumed by users in a variety of different formats and from a variety of different sources. One source of the content includes customers 141 or service providers 161. For example, customers 141 may utilize the networking platform 202 to initiate informational campaigns used to introduce or promote content, e.g., created by service providers 161, to users 152. In various embodiments described hereby, the networking platform 202 may include various techniques and functionalities to assist customers 141 in assessing the success of the informational campaign, e.g., based on notifications or alerts indicating whether the users 152 are interacting with the content on the networking platform 202.

The user plane 214 of networking platform 202 includes user interface data 220, a user interaction monitor 222, an interaction data collector 224, and one or more user experience components 226. As previously mentioned, the user plane 214 may be utilized by consumers of content on the networking platform 202. For example, a user may utilize the GUI 212 on user device 152 to log into and consume content from the networking platform 202 via network 102. Accordingly, the components of user plane 214 may support user interactions with the networking platform 202. In various embodiments, this may be achieved, at least in part, by the dynamic generation and exchange of instances of user interface data 220 between user device 152 and the components of the user plane 214. For example, at a first instance user interface data 220 may include data indicative of a selection made by a user on GUI 212 and at a second instance user interface data 220 may include content provided to the user device 152 by networking platform 202 in response to the selection made by the user. In many embodiments, user interface data 220 may include interaction data associated with content.

The customer plane 216 of networking platform 202 includes client interface data 230, a client interaction monitor 232, a performance metric manager 234, a notification administrator 236, one or more client experience components 238, and a data store 240. As previously mentioned, the client plane 216 may be utilized by customers 141 to launch informational campaigns on the networking platform 202. For example, a client may utilize the GUI 210 on client device 142 to initiate an informational campaign to provide content to and analyze performance of content on the networking platform 202 via network 102. Accordingly, the components of customer plane 216 may support interactions between customers 141 and the networking platform 110. In various embodiments, this may be achieved, at least in part, by the dynamic generation and exchange of instances of client interface data 230 between customer device 142 and the components of the customer plane 216. For example, at a first instance client interface data 230 may include data indicative of performance metrics corresponding to informational content and provided to the customer device 142 by networking platform 202 and at a second instance client interface data 230 may include data indicative of a point of interest selected by a customer via GUI 210 in response to presentation of the performance metrics.

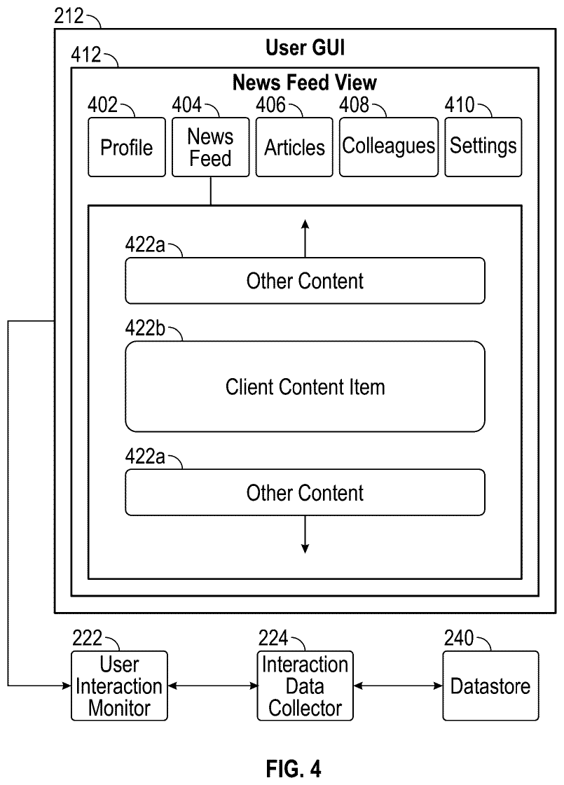

Referring to interactions between user device 152 and the networking platform 202, an exemplary operational flow for the networking platform 110 may proceed as follows. A user may be presented various content and may interact with the various content via GUI 212 of user device 152. Presentation of the various content via the user device 104 is described in more detail below, such as with respect to FIG. 4. User interface data 220 may be generated and transmitted to the user plane 214 via network 102 based on the user input provided via GUI 212. User interaction monitor 222 may analyze the user interface data 220 to inform various user experience components 226 on what data should be provided in response (e.g., included in user interface data 220 provided back to user device 152). For example, user interaction monitor 222 may track cursor position, clicks, dwell time, view time, scroll position, and the like.

Additionally, user interaction monitor 222 may identify the portions of the user interface data 220 that corresponds to the user interactions and provide this data to interaction data collector 224. For example, user interaction monitor 222 may identify interaction data associated with content. In some embodiments, the user interaction monitor 222 may provide the interaction data to the interaction data collector 224. In some such embodiments, the user interaction monitor 222 may provide an indication of the content associated with the interaction data to the interaction data collector 224. In response, interaction data collector 224 may store the interaction data in the data store 240. In various embodiments, interaction data collector 224 may perform one or more operations on the interaction data prior to storing it in data store 240. For example, interaction data collector 224 may classify, format, condition, filter, tag, and/or normalize the interaction data prior to storing it in data store 240. In one embodiment, the interaction data collector 224 may associate (e.g., tag) the interaction data with various items of related information, such as related content items, classifications, portions of content, clients, users, where/how the content was presented, and the like prior to storing the user interaction data in data store 240. For example, interactions may be classified based on whether users engaged with content to a predetermined depth, e.g., for a predetermined duration (e.g., <5 seconds classified as a light engagement and >5 seconds classified as a deep engagement). It will be appreciated that similar procedures may occur for several users on a several user devices to populate the data store 240 with user interaction data. Additionally, one or more of these operations may be performed by other components of the networking platform 202 without departing from the scope of this disclosure. For example, the operations performed on the user interaction data prior to storing it in the data store 240 may alternatively be performed by the performance metric manager 234 after the data is stored in data store 240.

Referring to interactions between customer device 142 and the networking platform 202, an exemplary operational flow for the networking platform 110 may proceed as follows. A customer may access the networking platform 202 via customer device 142 and utilize GUI 210 to navigate to various GUIs, such as a new campaign GUI or a content library GUI, as described below. Client interface data 230 may be generated and transmitted to the customer plane 216 via network 102 based on the client input provided via GUI 142 selecting a content item from the library of client content. Client interaction monitor 232 may analyze the client interface data 230 to inform various client experience components 238 on what data should be provided in response (e.g., included in user interface data 220 provided back to user device 152). For example, client interaction monitor 232 may track cursor position, clicks, dwell time, view time, scroll position, and the like. Additionally, client interaction monitor 232 may inform the performance metric manager 234 that a portion of the client interaction monitor 232 corresponds to selection of a particular content item. In response, the performance metric manager 234 may query the data store 240 to obtain user interaction data relevant to the particular content item.

The performance metric manager 234 may then determine one or more user interaction metrics and a set of corresponding values based on the client interaction data relevant to the particular content item. More generally, the performance metric manager 234 may operate to determine and/or generate data and metrics that support customer assessment of user interactions and/or cessation of user interactions with content. For example, the performance metric manager 234 may determine behavior data corresponding to a behavior metric, such as a number or degree of interactions of users with content.

In various embodiments, the performance metric manager 234 may perform various operations on the user interaction data 220 retrieved from the data store 240 prior to determining metrics and/or corresponding values. In various such embodiments, the performance metric manager 234 may deduplicate, filter, or consolidate the data, such as based on parameters and thresholds. For example, the performance metric manager 234 may identify the most significant interaction each user had with the content and filter out the remaining user interaction data. In some such examples, the most significant interaction with content may refer to their longest interaction with the content (e.g., the longest amount of a video viewed by each user). In another example, user interactions that do not exceed a threshold amount of time (e.g., 1 or 2 seconds) may be filtered out. In many embodiments, these operations performed on the user interaction data prior to determining metrics and/or corresponding values may be utilized to ensure that the data presented to clients is accurate and reliable. It will be appreciated that, one or more of these operations may be performed by other components of the networking platform 202 without departing from the scope of this disclosure. For example, the operations performed on the user interaction data 220 by performance metric manager 234 may be performed by interaction data collector 224 prior to being stored in the data store 240.

The notification administrator 236 may be configured to provide notifications to clients when certain thresholds or conditions are met with respect to content performance. For example, the customer may be notified of whether the behavior data meets target values established for a content campaign, as described below. In some embodiments, the notifications may be included in client interface data 230 and/or displayed in a dashboard of the customer GUI 210, as described below. In an embodiment, the notifications may be included in email or text messages.

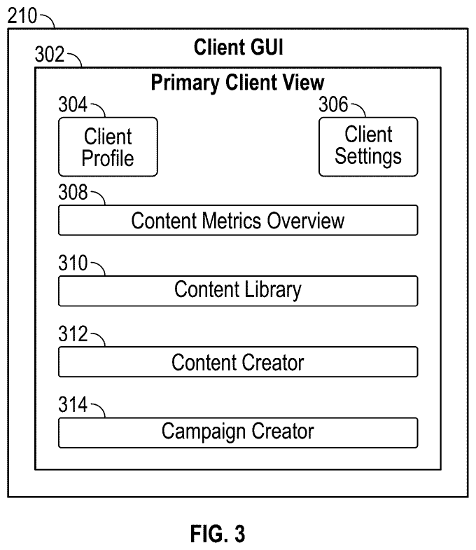

Referring to FIG. 3, a graphical user interface (GUI) provided by a networking platform is shown in accordance with one or more embodiments of the disclosure. The client GUI 210 can include a primary client view 302. Generally, the client GUI 210 may enable a client to configure and manage content on the networking platform. Advantageously, the client GUI 210 facilitates assessment of the content by clients based on user interactions with the content, such as by enabling clients to view various information, insights, and metrics regarding user interactions with content they have provided to the networking platform.

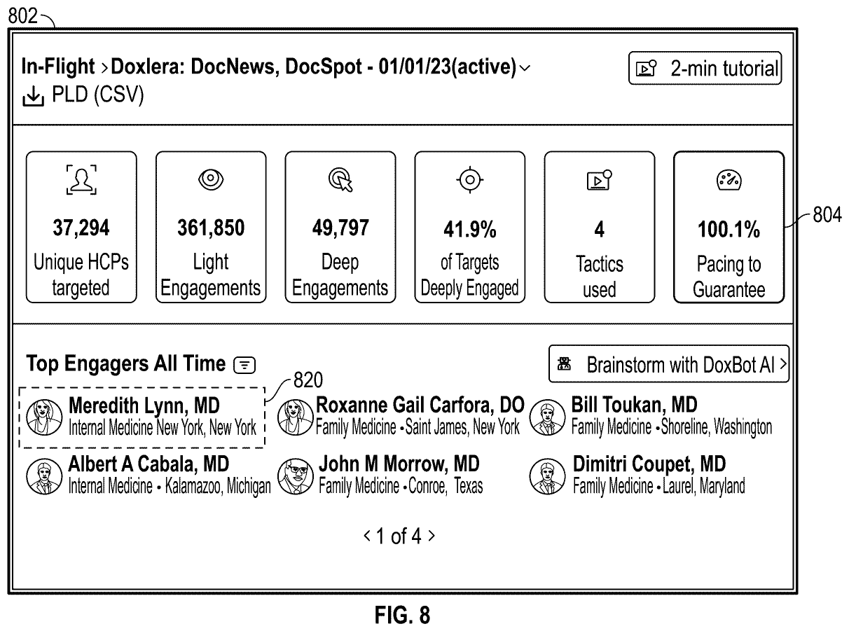

The client GUI 210 may provide a variety of functions, interfaces, and views for a client to interact with the networking platform. In the primary client view 302, a client may be provided with access to a client profile 304, client settings 306, a content metrics overview 308, a content library 310, a content creator 312, and a campaign creator 314. The client profile 304 may allow clients to view account information, such as client information, privileges, subscriptions, and the like. In various embodiments, one or more thresholds or parameters disclosed hereby, such as filters and thresholds for basing user interaction metrics or notification triggers may be defined via the client settings 306. Content metrics overview 308 may include various overview data corresponding to content of a client, such as a summary view of the performance of client content. For example, the content metrics overview 308 may include at least one of unique healthcare providers targeted, light engagements, deep engagements, percent of targets deeply engaged, tactics utilized, pacing to guarantee, and top engagers (FIG. 8). Additionally, some embodiments may include functionality to export various content metrics, such as physician level data. In some embodiments, the performance of client content may be compared to target benchmarks in the content metrics overview 308.

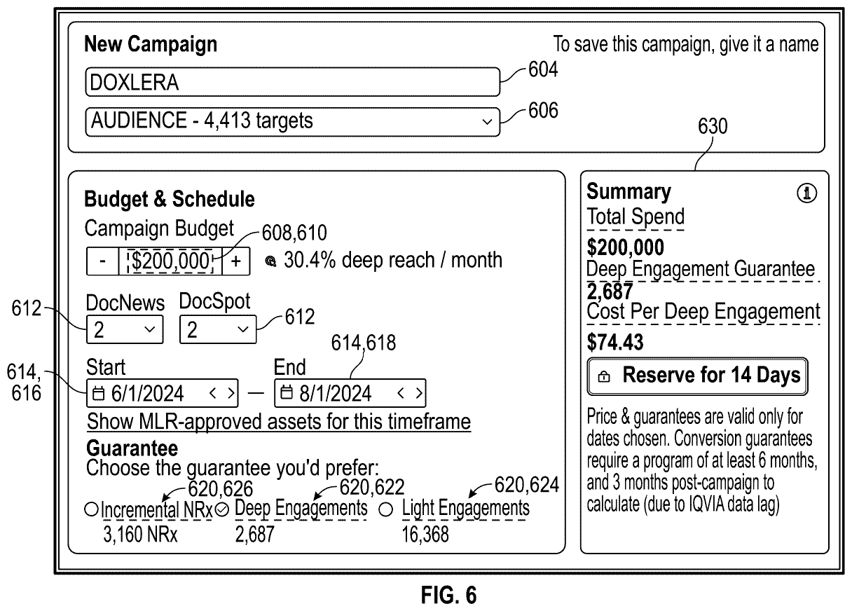

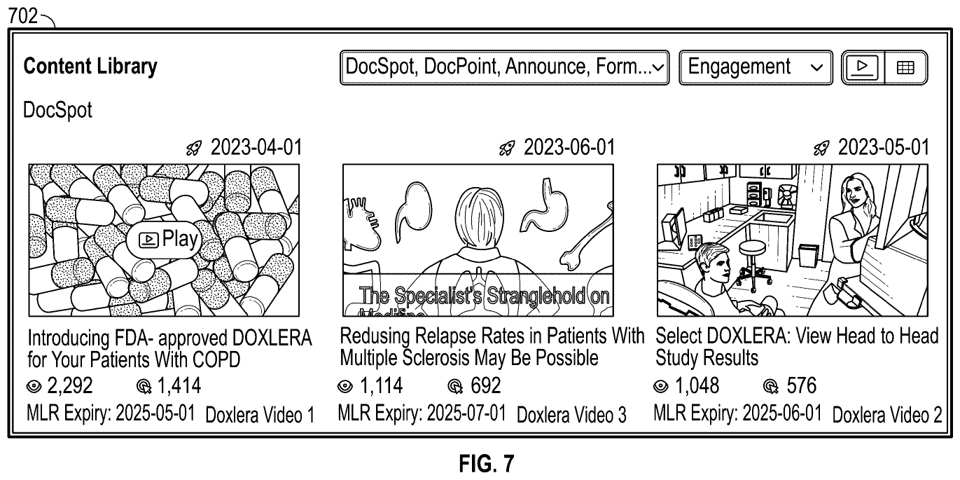

The content library 310 may enable a client to view the content they have provided to the networking platform (FIG. 7). The content creator 312 may provide clients with various tools for creating, uploading, formatting, and testing content on the networking platform. For example, the content creator 312 may enable clients to preview how content will be presented to users on the platform. In another example, the content creator 312 may enable clients to add banners, titles, subtitles, content (e.g., primary content), and the like to configure or create a content item. The campaign creator 314 may enable clients to initiate a content campaign to promote content to users as well as configure the promotion of the content, such as by selecting where on the networking platform the content is presented (e.g., in the news feed). The campaign creator 314 can enable a client to enter campaign data for the content campaign, which may be used to determine a target value for a behavior metric (FIG. 6.)

Referring to FIG. 4, a GUI provided by a networking platform, in accordance with one or more embodiments of the disclosure. In an embodiment, the user GUI 212 communicates with the user interaction monitor 222, the interaction data collector 224, and the datastore 240, as described above. The user GUI 212 may be utilized by users to interact (e.g., view, access, consume, etc.) with content provided by the networking platform. The interaction data collector 224 may operate to populate the datastore 240 with data regarding user interactions with content based on output of the user interaction monitor 222.

The user GUI 212 may provide a variety of ways for users to interact with the networking platform and content provided via the networking platform. For example, a user may access their profile 402, a news feed 404, articles 406, colleagues 408, and settings 410 via the user GUI 212. The illustrated embodiment includes a news feed view 412 that enables users to interact with content. The news feed view 412 may include a view that allows users to scroll through various items of content. This content may include content from a variety of sources, such as other users, third-party sources, and clients. In the exemplary embodiment of FIG. 4, this content includes other content 420a, client content item 422b, and other content 422c.

Additionally, other views may be available for users to interact with content. For example, selecting articles 406 may provide users with a view that focuses on content from academic publications and selecting colleagues 408 may provide users with a view that focuses on content provided by colleagues (or other professionals) on the networking platform. Each of these views may also include client content. In some embodiments, client content may be provided to users of the networking platform based on contractual agreements between the networking platform 202 and various customers. In various embodiments, the user interaction monitor 222 may monitor the interactions of users with content presented to them. Interaction data collector 224 may generate data based on these interactions, such as view time, and store this data in datastore 240, to support assessment of user interactions with content, as described in more detail below.

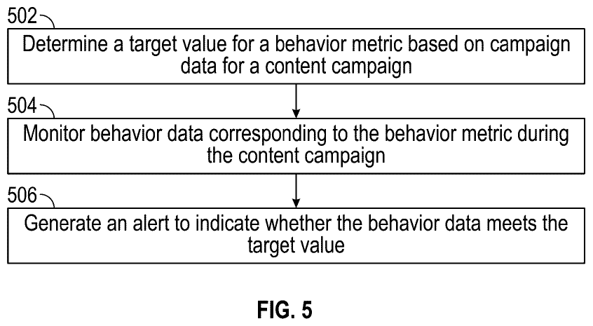

Referring to FIG. 5, a flowchart of a method of supporting assessment of user interactions with content is shown in accordance with one or more embodiments of the disclosure. Operations of the method are illustrated with respect to FIGS. 6-8. Accordingly, FIGS. 5-8 are alternately referred to below.

Referring to FIG. 6, a GUI provided by a networking platform is shown in accordance with one or more embodiments of the disclosure. A method of supporting assessment of user 151 interaction with content can allow content campaigns to be initiated by a customer 141 through the campaign creator 314. More particularly, the customer 141 can access a new campaign GUI 602 of a self-serve portal hosted by server(s) 104. The new campaign GUI 602 allows customers 141 to plan a content campaign and, during the planning process, receive a prediction or guarantee of user engagement or influence with content of the campaign.

To initiate the content campaign, the customer 141 can enter campaign data representing information about the campaign. For example, the customer 141 may enter product name data 604 representing a name or brand of a product, e.g., a pharmaceutical product, for which informational content will be distributed. As an example, the customer 141 has entered “Doxlera,” which is a name of a medicine that the customer 141 wants to educate a group of users 151, e.g., healthcare professionals, about during the content campaign.

Campaign data can include audience data 606. Audience data 606 may be representative of a target audience for the content campaign. The audience data 606 can include a listing of users 151, e.g., physicians, that the content of the content campaign may be relevant to. In an embodiment, the audience data 606 can be uploaded through the campaign creator and/or new campaign GUI 602. For example, a CSV file containing a listing of National Provider Identifiers (NPIs) can be uploaded as the target audience. In the example shown, the listing includes 4,413 NPIs. NPIs are unique 10-digit identification numbers issued to health care providers in the United States. Accordingly, the target audience can include a predetermined group of individuals that are uniquely identifiable.

Campaign data can include spend data 608. Spend data 608 may be representative of an amount of money that the customer 141 is willing to spend on the campaign. The spend data 608 can include a budget value 610, which may be an amount that the customer 141 will agree to spend on the campaign when it is launched. For example, the budget value 610 is $200,000 in the illustrated example, and the customer 141 will spend that amount on the informational campaign through the networking platform 202, if launched. More particularly, the content campaign can be hosted by the entity operating the server(s) 104 in exchange for the budget value.

Campaign data can include content data 612. Content data 612 can identify content to be displayed to users 151 during the content campaign. More particularly, the content data 612 can indicate a type and/or amount of content tactics that will be used in the informational campaign. A content tactic can be a type of content to be presented to the users 151. For example, “DocNews” can represent the content tactic that includes presenting articles to the users 151. Similarly, “DocSpot” can represent that content tactic that includes presenting videos to the users 151. Accordingly, the content to be displayed to users 151 during the content campaign can include one or more of an article or a video, e.g., related to a pharmaceutical product.

The content data 612 can be entered via interaction with a drop down menu. For example, a drop down menu has been used to select “2,” indicating that two separate articles will be used throughout the campaign. Similarly, a drop down menu has been used to select “2,” indicating that two separate videos will be used throughout the campaign. The content data 612 identifies the type of tactics and specifies the number of individual items of each type of content that will be ordered for the campaign.

Referring to FIG. 7, a GUI provided by a networking platform is shown in accordance with one or more embodiments of the disclosure. Selection of content data 612 can include selection of specific content from a content library 702. The content library 702 can include the content eligible or relevant for use in the content campaign. The content library 702 can include, for example, thumbnails of videos (“DocSpots”) that can be presented to users 151 during the informational campaign. The content can be specific to the subject of the campaign. For example, in response to receiving “Doxlera” as the product name data 604, the system may populate the content library 702 with articles and videos specific to the Doxlera product. The customer 141 may then easily review and approve, e.g., select, the content from the content library 702 as a tactic to be used in the campaign.

The content library 702, which can be displayed during the campaign ordering process, may display only approved assets. Approved assets can include content that has Medical Legal Review (MLR) approval. More particularly, the content displayed for selection in the content library 702 can be MLR-approved content. The MLR approval may be valid (unexpired) during a timeframe chosen for the content campaign.

Referring again to FIG. 6, campaign data can include timeframe data 614. Timeframe data 614 can include data identifying an overall duration of the campaign. For example, the timeframe data 614 can include a start date 616 and an end date 618 of the content campaign. The dates may be selected via interaction with drop down menus, as shown. Alternatively, the dates may be entered through interaction with a calendar element, numerical entry, etc.

The new campaign GUI 602 allows for the entry of inputs, as described above, including who will be targeted with information during the campaign, how long the campaign will last, how much the investment in information distribution will be, as well as the types of information that will be distributed. More particularly, the new campaign GUI 602 can receive user entries inputting data corresponding to characteristics of the informational campaign. Based on such inputs, the system can output guarantees, which may be self-served by the customer 141 through the new campaign GUI 602, to evaluate cost efficacy of the proposed campaign. More particularly, at operation 502, the processing device 204 can determine a target value 620 for a behavior metric based on the campaign data for the content campaign.

The system can store historical data relevant to the target audience. The target audience, or users 151 having characteristics similar to the target audience, may have interacted with the networking platform 202 on past occasions. For example, a customer 141 having a NPI number may have viewed content related to another product that competes with the subject medicine of the informational campaign. That behavior may be relevant to determining whether and how the customer 141 may engage with content from the informational campaign, and can be stored by the system. Data corresponding to the NPIs of the target audience may be, for example, data representing content that each physician (as represented by a NPI number) has read, watched, or written on the platform can be collected. Data related to the target audience can also include a type of content that the target audience typically engages with, e.g., articles or videos, how often and how long the audience engages with content, etc. Accordingly, the historical data stored by the system can represent habits that the audience has related to content interaction.

In addition to historical content consumption data, the system may receive or store data relevant to prescriptive behaviors of the target audience. More particularly, additional data that can correspond to the audience data 606 can include historical prescription data that indicates whether the physicians have prescribed certain pharmaceutical products in the past, how often such prescriptions were made, etc. The historical prescription data can represent behavior in response to viewed content. For example, the system may store influence data indicating that a physician having a NPI number prescribed a medicine more frequently after reading an informational article, but not after watching an informational video. The correlation may be identified and used to predict that the physician is more likely to prescribe medicines in response to articles than videos. Accordingly, the historical data stored by the system can represent habits that the audience has related to prescribing pharmaceutical products.

The historical data, and other data or data correlations stored by the system, can be used to determine the target value 620 for the behavior metric at operation 502. In an embodiment, the behavior metric is a measurement of how often and to what level users 151 of the target audience engage with content of the content campaign. For example, the behavior metric can be deep engagements or light engagements by the target audience with the content. The target value 620 in such case can be a number of user engagements with content for a predetermined duration. More particularly, the target value 620 is a deep engagement target value 622 when the predetermined duration is more than a time threshold (e.g., >5 seconds). The deep engagement target value 622 is illustrated as “2,687” in the example. By contrast, the target value 620 is a light engagement target value 624 when the predetermined duration is less than the time threshold (e.g., <5 seconds). The light engagement target value 624 is illustrated as “16,368” in the example. The engagement target values 620 can be determined based on the campaign data inputs and the stored historical data to provide a prediction (or a guarantee) of how deeply the customer 141 can expect the target audience to engage with the selected content during the content campaign.

In an embodiment, the behavior metric is a measurement of how the users 151 of the target audience prescribe the pharmaceutical product that is the subject of the content campaign. For example, the target value 620 can be a number of new prescriptions of the pharmaceutical product, which is the subject of the content campaign, by the target audience during the campaign. The new prescription target value 626 is illustrated as “3,160” in the example. The prescription target values 620 can be determined based on the campaign data inputs and the stored historical data to provide a prediction (or a guarantee) of how users will be influenced. For example, the values can represent how many incremental new prescriptions of the subject medicine the target audience can be expected to make during the content campaign. More particularly, the incremental NRx value can guarantee a new prescription lift that the customer 141 can expect from the content campaign based on how groups of users 151 have responded to content campaigns in the past.

The new campaign GUI 602 can provide additional information to the customer 141 within the self-serve portal. For example, the determination of the target values 620 may be based on a calculated expected percentage of reach per month, e.g., how well the campaign is expected to reach the target audience, which can be displayed to the customer 141. In the illustrated example, the reach per month is 30.4% of the target audience.

In an embodiment, the new campaign GUI 602 can include a summary 630 of the content campaign. The summary 630 can display the budget value 610, the selected guarantees (which in the illustrated example includes the deep engagement target value 622), and a cost per target value 620. The cost per target value 620 may be a cost per engagement (CPE) as shown. The CPE value can be calculated as the spend divided by the engagements in the example. It will be appreciated that the customer 141 can select additional guarantees, such as the new prescription target value 626 or the light engagement target value 624 and that such target values 620 may be used to generate corresponding summary sections. Accordingly, the customer 141 can quickly determine an investment required per user behavior (engagements or prescriptions). With such information, the customer 141 can make a confident decision about the value of initiating the content campaign.

The inputs and outputs of the new campaign GUI 602 and, more particularly, the determination of target values 620 of the behavior metric, can be dynamically determined. For example, adjusting the campaign budget using a plus or minus icon can change the budget value 610, which can automatically change the guarantee and summary information. Accordingly, guarantees and decisions about whether to order the content campaign can be made in real time.

Relationships between the inputs of the self-serve portal and the historical data stored by the system can be used to make the determination of the target values 620 in a manner that may not be immediately apparent. For example, the engagement with content or new prescriptions made by users 151 can be seasonally affected. By way of example, users 151 may tend to prescribe more medicines during the last quarter of the year. Such trends may be determined from the stored prescription data and used in determining the new prescription target value 626. More particularly, a season of the content campaign can be determined based on the timeframe data 614, and the target value 620 may be determined (at operation 502) based on the season. When the timeframe data 614 indicates that the content campaign will occur during the last quarter of the year, then the guarantee of new prescriptions may be higher than would be the case if the content campaign is run during the second quarter of the year. The relationships between the inputs, stored data, and output data can be encoded in an algorithm that the processing device 204 uses to determine the target values 620.

Referring to FIG. 8, a GUI provided by a networking platform is shown in accordance with one or more embodiments of the disclosure. At operation 504, behavior data corresponding to the behavior metric is monitored during the content campaign. After reviewing and approving the content campaign through the new campaign GUI 602, the campaign can be ordered and launched. More particularly, the server(s) 104 can host the networking platform 202 to present the selected content to the target audience over the agreed upon timeframe. As described above, data can be collected from the user computing devices during the campaign, and stored for real-time tracking of the campaign. The real-time tracking can include notifying or alerting customers 141 to the behavior metric values, as compared to the target values 620 that were guaranteed when the content campaign was ordered.

Several icons can be generated and displayed in a campaign tracking dashboard 802. The dashboard 802 can be a graphical user 151 interface of a display of the system. The dashboard 802 can provide information about the content campaign. For example, clicking into the dashboard 802 can cause display of several metrics. More particularly, campaign and behavior data associated with the content campaign can be represented graphically, including: a number of users targeted by the content campaign (e.g., 37,294), a number of light engagements (e.g., 361,850), a number of deep engagements (e.g., 49,797), a percentage of deeply engaged targets (41.9%), and a number of tactics used (e.g., 4). The data can provide, at a glance, key information about the content campaign that allows the customer 141 to track and understand the success of the content campaign.

In an embodiment, at operation 506, the system generates a notification 804 to indicate whether the behavior data meets the target value 620. The notification 804 can indicate, for example, how the content campaign is pacing relative to the guarantee that was provided by the new campaign GUI 602 when the campaign strategy was set and initiated. In the example, an amount of deep engagements (e.g., 49,797) is 100.1% of the deep engagement target value 622 that was determined at operation 502 through the new campaign GUI 602. The customer 141 can therefore use the dashboard 802 to assess the performance of the campaign, and can quickly see that the expected outcome of the campaign is being achieved.

In an embodiment, the dashboard 802 can display one or more user profiles 820. The user profiles 820 may, for example, be associated with a group of the target audience meeting a predetermined characteristic. The predetermined characteristic can be a top engager status, which may be defined as a user 151 that exceeds a predetermined threshold of behavior, e.g., engagements or prescriptions. For example, the predetermined threshold can be a minimum number of deep engagements with content in the content campaign, or a minimum number of new prescriptions of the pharmaceutical product that is the subject of the campaign. In an embodiment, the user profiles 820 of those users 151 that have the highest value for the behavior metric can be displayed. For example, six users 151 with the most deep engagements from the content campaign are illustrated in FIG. 8.

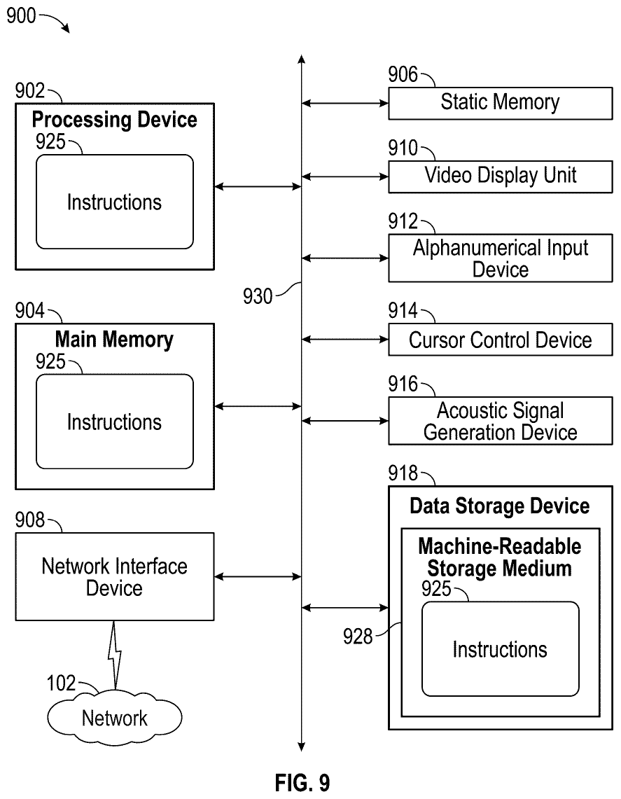

Referring to FIG. 9, a block diagram of an example system is shown in accordance with one or more embodiments of the disclosure. Computing device 900 is representative of any of the computing devices 104, 142, 152, or 162 described above. The computing device 900 may be connected to other computing devices in a LAN, an intranet, an extranet, and/or the Internet. The computing device 900 may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 900 may include a processing device 902 (e.g., a general purpose processor, a PLD, etc.), a main memory 904 (e.g., synchronous dynamic random access memory (DRAM), read-only memory (ROM)), a static memory 906 (e.g., flash memory and a data storage device 918), which may communicate with each other via a bus 930.

Processing device 902 may be provided by one or more general-purpose processing devices such as a microprocessor, central processing unit, or the like. In an illustrative example, processing device 902 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 902 may also include one or more special-purpose processing devices such as an application specific integrated circuit (ASIC), a field programmable gate array (FPGA), a digital signal processor (DSP), network processor, or the like. The processing device 902 may execute the operations described herein, in accordance with one or more aspects of the present disclosure, for performing the operations and steps discussed herein.

Computing device 900 may further include a network interface device 908 which may communicate with a network 102. The computing device 900 also may include a video display unit 910 (e.g., a liquid crystal display (LCD) or a cathode ray tube (CRT)), an alphanumeric input device 912 (e.g., a keyboard), a cursor control device 914 (e.g., a mouse) and an acoustic signal generation device 916 (e.g., a speaker). In one embodiment, video display unit 910, alphanumeric input device 912, and cursor control device 914 may be combined into a single component or device (e.g., an LCD touch screen).

Data storage device 918 may include a machine-readable storage medium 928 on which may be stored one or more sets of instructions 925 that may include instructions for a component (e.g., one or more components of networking platform 202, user device 212, and/or client device 210) for carrying out the operations described herein, in accordance with one or more aspects of the present disclosure. Instructions 925 may also reside, completely or at least partially, within main memory 904 and/or within processing device 902 during execution thereof by computing device 900, main memory 904 and processing device 902 also constituting computer-readable media. The instructions 925 may further be transmitted or received over a network 102 via network interface device 908.

While machine-readable storage medium 928 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding, or carrying a set of instructions for execution by the machine and that cause the machine to perform the methods described herein. The term “computer-readable storage medium” shall accordingly be taken to include, but not be limited to, solid-state memories, optical media, and magnetic media.

Unless specifically stated otherwise, terms such as “presenting,” “determining,” “analyzing,” “retrieving”, “transforming”, “generating”, or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general purpose computing device selectively programmed by a computer program stored in the computing device. Such a computer program may be stored in a computer-readable non-transitory storage medium. More particularly, the non-transitory computer-readable can store instructions that, when executed by the processing device 204, causes the processing device to perform the methods described herein.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a,” “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting. As used herein, the term “and/or” includes any and all combination of one or more of the associated listed items.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

1. A method comprising:
receiving historical behavior data representing content interaction habits of a target audience;
determining, by a processing device, a guarantee target value for a behavior metric, wherein the guarantee target value is determined based on the historical behavior data and campaign data for a content campaign, and wherein the campaign data includes a listing of National Provider Identifiers (NPIs) issued to healthcare providers in the target audience having the content interaction habits represented by the historical behavior data;
monitoring current behavior data corresponding to the behavior metric during the content campaign; and
generating a notification to indicate pacing of the current behavior data to the guarantee target value.

2. The method of claim 1, wherein the campaign data includes audience data, and wherein the audience data includes the listing of National Provider Identifiers.

3. The method of claim 1, wherein the campaign data includes spend data, and wherein the spend data includes a budget value for the content campaign.

4. The method of claim 1, wherein the campaign data includes content data, and wherein the content data identifies content to be displayed to users during the content campaign.

5. The method of claim 4, wherein the content includes one or more of an article or a video related to a pharmaceutical product.

6. The method of claim 1, wherein the campaign data includes timeframe data, and wherein the timeframe data includes a start date and an end date of the content campaign.

7. The method of claim 6 further comprising determining, based on the timeframe data, a season of the content campaign, wherein the guarantee target value is determined based on the season.

8. The method of claim 1, wherein the guarantee target value is a number of user engagements with content for a predetermined duration.

9. The method of claim 8, wherein the predetermined duration is more than a time threshold.

10. The method of claim 8, wherein the predetermined duration is less than a time threshold.

11. The method of claim 1, wherein the guarantee target value is a number of new prescriptions of a pharmaceutical product.

12. The method of claim 1 further comprising displaying, in a graphical user interface of a display, one or more user profiles associated with behavior metrics exceeding a predetermined threshold of behavior.

13. A system comprising:
a memory to:
store historical behavior data representing content interaction habits of a target audience, and
store campaign data for a content campaign; and
a processing device, operatively coupled to the memory, to:
determine a guarantee target value for a behavior metric, wherein the guarantee target value is determined based on the historical behavior data and the campaign data, and wherein the campaign data includes a listing of National Provider Identifiers (NPIs) issued to healthcare providers in the target audience having the content interaction habits represented by the historical behavior data,
monitor current behavior data corresponding to the behavior metric during the content campaign, and
generate a notification to indicate pacing of the current behavior data to the guarantee target value.

14. The system of claim 13, wherein the campaign data includes one or more of audience data, spend data, content data, or timeframe data, wherein the audience data includes the listing of National Provider Identifiers, wherein the spend data includes a budget value for the content campaign, wherein the content data identifies content to be displayed to users during the content campaign, and wherein the timeframe data includes a start date and an end date of the content campaign.

15. The system of claim 13, wherein the guarantee target value is a number of user engagements with content for a predetermined duration.

16. The system of claim 13, wherein the guarantee target value is a number of new prescriptions of a pharmaceutical product.

17. A non-transitory computer-readable storage medium including instructions that, when executed by a processing device, cause the processing device to:
receive historical behavior data representing content interaction habits of a target audience;
determine a guarantee target value for a behavior metric, wherein the guarantee target value is determined based on the historical behavior data and campaign data for a content campaign, and wherein the campaign data includes a listing of National Provider Identifiers (NPIs) issued to healthcare providers in the target audience having the content interaction habits represented by the historical behavior data;
monitor current behavior data corresponding to the behavior metric during the content campaign; and
generate a notification to indicate pacing of the current behavior data to the guarantee target value.

18. The non-transitory computer-readable storage medium of claim 17, wherein the campaign data includes one or more of audience data, spend data, content data, or timeframe data, wherein the audience data includes the listing of National Provider Identifiers, wherein the spend data includes a budget value for the content campaign, wherein the content data identifies content to be displayed to users during the content campaign, and wherein the timeframe data includes a start date and an end date of the content campaign.

19. The non-transitory computer-readable storage medium of claim 17, wherein the guarantee target value is a number of user engagements with content for a predetermined duration.

20. The non-transitory computer-readable storage medium of claim 17, wherein the guarantee target value is a number of new prescriptions of a pharmaceutical product.
